(19) United States
(12) Patent Application Publication
(10) Pub. No.: US 2018/0217720 A1
(43) Pub. Date: Aug. 2, 2018

(54) TRACK USER PROGRESS WHILE NAVIGATING APPLICATION ACROSS MULTIPLE ENDPOINTS

(71) Applicant: Microsoft Technology Licensing, LLC, Redmond, WA (US)

(72) Inventors: Carlos German Perez, Seattle, WA (US); Reema Bhagat, Seattle, WA (US); Edgar Alberto Banguero, Seattle, WA (US); Max Lustig, Seattle, WA (US); Oleksandr Boyko, Redmond, WA (US); Arwa Zoher Tyebkhan, Redmond, WA (US); Sari Jack, Seattle, WA (US)

(21) Appl. No.: 15/422,959

(22) Filed: Feb. 2, 2017

(51) Int. Cl. G06F 3/0482

(52) U.S. Cl. CPC G06F 3/0482; H04L 67/10

(57) ABSTRACT

Aspects of the present disclosure relate to systems and methods for tracking user progress as a user navigates an application across multiple endpoints. In one aspect, an action control may be presented within an application including a plurality of actions to be completed by a user while using the application. At least a first action of the plurality of actions may be presented in the action control when the application is accessed by a first endpoint. Subsequent to the first action being completed, at least a second action may be presented in the action control when the application is accessed by a second endpoint. At least one action of the plurality of actions is associated with an endpoint on which the action is to be completed.

### BACKGROUND

Computer and software users have grown accustomed to user-friendly software applications for co-authoring files, documents, messages, and the like. For example, storage providers (e.g., cloud storage providers) provide applications where users can co-author and collaborate with one another within the applications. In this regard, a user may access a storage provider via an application using a variety of endpoints. However, learning how to navigate an application associated with a storage provider may be based on a single application for accessing the storage provider (e.g., web access to the storage provider). As such, it may be challenging for users to navigate storage providers, ultimately leading to a lack of participation in the use of storage providers and/or applications associated with storage providers.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In summary, the disclosure generally relates to systems and methods for tracking user progress as a user navigates an application across multiple endpoints. In one aspect, an action control may be presented within an application including a plurality of actions to be completed by a user while using the application. At least a first action of the plurality of actions may be presented in the action control when the application is accessed by a first endpoint. Subsequent to the first action being completed, at least a second action may be presented in the action control when the application is accessed by a second endpoint. At least one action of the plurality of actions is associated with an endpoint on which the action is to be completed.

In another aspect, a method for facilitating user progress while navigating an application is presented. A request may be sent to an application service associated with the application for a current user progression state corresponding to an action of a plurality of actions to be completed by a user while using the application. A response to the request may be received. The response may include at least a next action of the plurality of actions to be completed by the user. At least the next action of the plurality of actions to be completed by the user may be presented within the application in a user interface of an endpoint. At least one action of the plurality of actions is associated with the endpoint on which the action is to be completed.

In yet another aspect, user progression states of an application across endpoints may be tracked. For example, a plurality of user progression states corresponding to a plurality of actions to be completed by a user while using the application may be stored. At least one of the plurality of user progression states may be updated when a first action of the plurality of actions is completed on a first endpoint. At least one of the plurality of user progression states may be updated when a second action of the plurality of actions to be completed by the user is completed on a second endpoint. At least one action of the plurality of actions is associated with an endpoint on which the action is to be completed.

### DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 illustrates an exemplary guided action system for tracking user progress while navigating an application across multiple endpoints, according to an example aspect.

FIG. 2A illustrates one view in a progression of views of an application, according to an example aspect.

FIG. 2B illustrates another view in the progression of views of the application of FIG. 2A, according to an example aspect.

FIG. 2C illustrates another view in the progression of views of the application of FIG. 2A, according to an example aspect.

FIG. 2D illustrates another view in the progression of views of the application of FIG. 2A, according to an example aspect.

FIG. 2E illustrates another view in the progression of views of the application of FIG. 2A, according to an example aspect.

FIG. 3A illustrates one view in a progression of views of an application, according to an example aspect.

FIG. 3B illustrates another view in the progression of views of the application of FIG. 3A, according to an example aspect.

FIG. 3C illustrates another view in the progression of views of the application of FIG. 3A, according to an example aspect.

FIG. 3D illustrates another view in the progression of views of the application of FIG. 3A, according to an example aspect.

FIG. 4 illustrates an exemplary method for facilitating user progress while navigating an application, according to an example aspect.

FIG. 5 illustrates an exemplary method for tracking user progression states of an application across multiple endpoints, according to an example aspect.

FIG. 6 illustrates a computing system suitable for implementing the enhanced guided action technology disclosed herein, including any of the environments, architectures, elements, processes, user interfaces, and operational scenarios and sequences illustrated in the Figures and discussed below in the Technical Disclosure.

### DETAILED DESCRIPTION

Aspects of the disclosure are generally directed to systems and methods for tracking user progress as a user navigates an application across multiple endpoints. For example, when a user launches an application (e.g., by signing in to the application), a plurality of actions for encouraging the user to engage with and return to the application and/or application service may be presented within the application. At least some of the plurality of actions may be associated with the endpoint on which the action is to be completed. For example, one of the actions may include downloading and accessing a sync client for engaging the application service. The sync client may be integrated with the file explorer of the endpoint for accessing files stored on the endpoint and/or application service. In this regard, downloading and accessing the sync client may be an action to be completed on a desktop computer and/or a tablet device, for example. In another example, one of the actions may include downloading and accessing a mobile application for engaging the application service. In this regard, downloading and accessing the mobile application may be an action to be completed on a mobile device such as a mobile phone and/or a tablet. Each action of the plurality of actions may be tracked and stored at the application service regardless of the endpoint used to complete an action such that a user of the application is aware of which actions she has completed. A user may be encouraged to complete the actions of the plurality of actions that have not been completed. In turn, a user is encouraged to engage with, participate in the use of, and return to the application.

As discussed above, storage providers (e.g., cloud storage providers) provide applications where users can co-author and collaborate with one another within the applications. In this regard, a user may access a storage provider via an application using a variety of endpoints. However, learning how to navigate an application associated with a storage provider may be based on a single application for accessing the storage provider (e.g., web access to the storage provider). As such, it may be challenging for users to navigate storage providers, ultimately leading to a lack of participation in the use of storage providers and/or applications associated with storage providers and/or application services.

Accordingly, aspects described herein include tools and/or techniques that make engaging with, participating in the use of, and returning to an application associated with an application service intuitive, user-friendly, and efficient. In one aspect, an action control may be presented within an application (e.g., SharePoint application, OneDrive application). The action control may include a plurality of actions to be completed by a user while using the application. A first action of the plurality of actions may be presented in the action control when the application is accessed by a first endpoint. In some examples, the first endpoint may include at least one of a mobile phone, a tablet device, and a desktop device. In one case, presenting the first action in the action control may include highlighting the first action such that it appears selected. By presenting and/or highlighting the first action in the action control, a user may be encouraged to complete the first action.

Subsequent to the first action being completed, a second action may be presented in the action control. In one example, the second action is presented in the action control when the application is accessed by a second endpoint. In another example, the second action is presented in the action control when the application is accessed by the first endpoint. In some examples, the second endpoint may include at least one of a mobile phone, a tablet device, and a desktop device. In this regard, the second endpoint may a similar type of endpoint as the first endpoint or a different type of endpoint as the first endpoint. In one case, presenting the second action in the action control may include highlighting the second action such that it appears selected. By presenting and/or highlighting the second action in the action control, a user may be encouraged to complete the second action. Any number of actions may be presented in the action control within the application to be completed by a user while using and/or navigating the application. In some cases, at least one action of the plurality of actions is associated with an endpoint on which the action is to be completed. For example, when the action includes downloading and/or accessing a mobile application, the endpoint on which the action is to be completed is at least one of a mobile phone and a tablet device. In another example, when the action includes accessing a sync client, the endpoint on which the action is to be completed is at least one of a desktop device and a tablet device. As such, by completing the plurality of actions associated with navigating the application across multiple endpoints, a user of the application may be encouraged to use the application, may be more productive while using the application, and accomplish tasks based on the endpoint (e.g., by being aware of which endpoint to use for which task). In turn, a technical effect that may be appreciated is that the tools and/or techniques disclosed herein provide a compelling visual and functional experience for users to engage with, navigate, and participate in the user of applications associated with an application service intuitively and efficiently through interaction with a user interface.

In another aspect, user progression states of an application across multiple endpoints may be tracked. For example, a plurality of user progression states corresponding to a plurality of actions to be completed by a user while using the application may be stored. In one example, the plurality of user progression states may be stored at an application service associated with the application (e.g., OneDrive, Sharepoint). In this regard, the state of the user and actions completed across multiple endpoints may be tracked. In one example, at least one of the plurality of user progression states may be updated when a first action of the plurality of actions is completed on a first endpoint. In another example, at least one of the plurality of user progression states may be updated when a second action of the plurality of actions to be completed by the user is completed on a second endpoint. In yet another example, at least one of the plurality of user progression states may be updated when any action of the plurality of actions to be completed by the user is completed on any endpoint. At least one action of the plurality of actions is associated with an endpoint on which the action is to be completed. In this regard, a user may become efficient with the application and/or application service with all endpoints on which the application and/or application service may be accessed. In addition, a user's progress with completing actions (e.g., becoming efficient) is tracked such that the user is aware and notified of completed actions and encouraged to complete the actions that have not been completed.

In this regard, another technical effect that may be appreciated is that the tools and/or techniques disclosed herein provide a compelling visual and functional experience for users to utilize applications across multiple endpoints intuitively and efficiently through interaction with a user interface. A further technical effect that may be appreciated is that user interaction with applications and/or application services across multiple endpoints is improved by tracking user progression states as a user completes actions across multiple endpoints and providing informational material associated with the application with each action, ultimately saving time and reducing processor load and conserving memory.

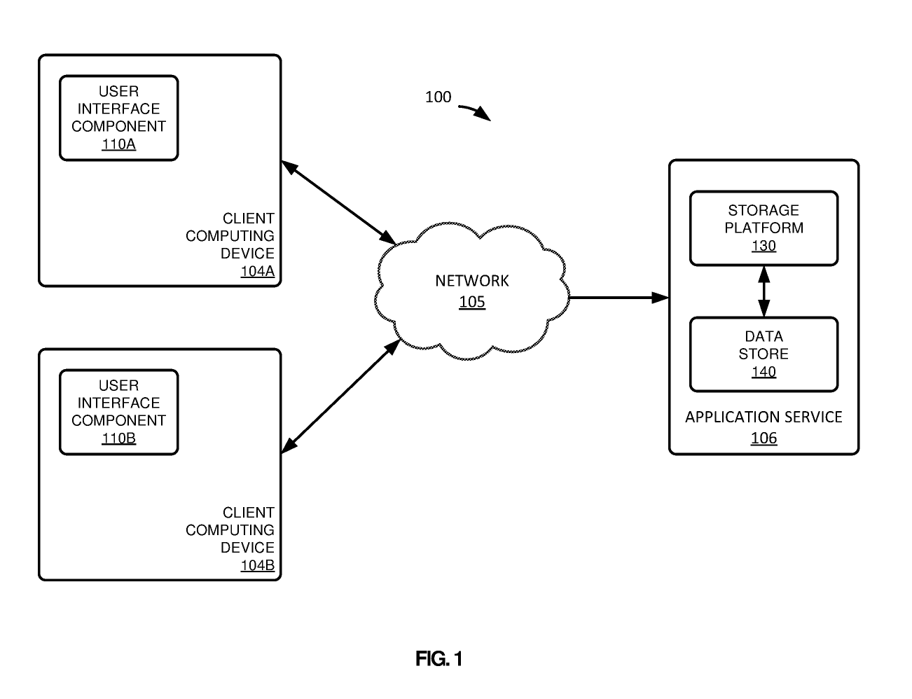

Referring now to the drawings, in which like numerals represent like elements through the several figures, aspects of the present disclosure and the exemplary operating environment will be described. With reference to FIG. 1, one aspect of a guided action system 100 for tracking user progress as a user navigates an application across multiple endpoints is illustrated. In aspects, the guided action system 100 may include client computing devices 104A-104B and an application service 106. In a basic configuration, the client computing devices 104A-104B may be a handheld computer having both input elements and output elements. The client computing devices 104A-104B may be any suitable computing device for implementing the guided action system 100 for tracking user progress as a user navigates an application across multiple endpoints. For example, the client computing devices 104A-104B may be at least one of: a mobile telephone; a smart phone; a tablet; a phablet; a smart watch; a wearable computer; a personal computer; a desktop computer; a laptop computer; a gaming device/computer (e.g., Xbox); a television; and etc. This list is exemplary only and should not be considered as limiting. Any suitable client computing devices 104A-104B for implementing the guided action system 100 for tracking user progress as a user navigates an application across multiple endpoints may be utilized. In one example, the client computing devices 104A-104B may include the endpoints, as discussed herein.

In aspects, the application service 106 may provide data to and from the client computing devices 104A-104B through a network 105. In aspects, the guided action system 100 may be implemented on more than one application service 106, such as a plurality of application service 106. As discussed above, the application service 106 may provide data to and from the client computing devices 104A-104B through the network 105. The data may be communicated over any network suitable to transmit data. In some aspects, the network is a distributed computer network such as the Internet. In this regard, the network may include a Local Area Network (LAN), a Wide Area Network (WAN), the Internet, wireless and wired transmission mediums. The data may be communicated in accordance with various communication protocols, combinations of protocols, or variations thereof. In one example, the data may be communicated in accordance with the HTTPS (Secure Hypertext Transfer Protocol).

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the aspects and functionalities described herein may operate over distributed systems (e.g., cloud-based computing systems), where application functionality, memory, data storage and retrieval, and various processing functions may be operated remotely from each other over a distributed computing network, such as the Internet or an Intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As discussed above, the guided action system 100 may include client computing devices 104A-104B and an application service 106. The various components may be implemented using hardware, software, or a combination of hardware and software. The guided action system 100 may be configured to track user progress as a user navigates an application across multiple endpoints (e.g., across client computing devices 104A-104B). In this regard, as illustrated in FIG. 1, the client computing devices 104A-104B include user interface components 110A-110B. In some examples, the user interface components 110A-110B may be configured to display an application for accessing and/or interacting with a dataset, the application service 106, and the like. In one example, an application may include any application suitable for accessing datasets (e.g., datasets stored at the application service 106) such as collaboration applications, email applications, chat applications, voice applications, and the like. In one example, a collaboration application may include an application such as a OneDrive application and a SharePoint application. In one case, items and/or files associated with the application and included in the dataset may include items and/or files such as word documents, spreadsheets, electronic slide presentations, emails, chat conversations, media files, and the like. In one example, the application is displayed in the user interface via the user interface components 110A-110B when the application is launched. In one example, the application may be opened and launched when an indication of interest made with respect to an icon, link, and the like, representing the application is received at the user interface of the client computing devices 104A-104B. In one example, an indication of interest may include touching, clicking on, audibly referencing, pointing to, selecting, and/or any indication of an interest in or selection of the icon, link, and the like, representing the application.

In some examples, the user interface components 110A-110B may be configured to present an action control within the application. In one example, the action control may be presented within the application when a user logs-in to and/or signs-in to the application. The action control may be a portion of the application for displaying actions to be completed by a user while navigating the application. In this regard, the action control may include a plurality of actions to be completed by a user while using the application. In one example, the action control may include informational material for each action. For example, when an action is presented and/or selected by a user within the action control, informational material may be presented with the action describing at least a function of performing the action and/or encouraging the user to complete the action.

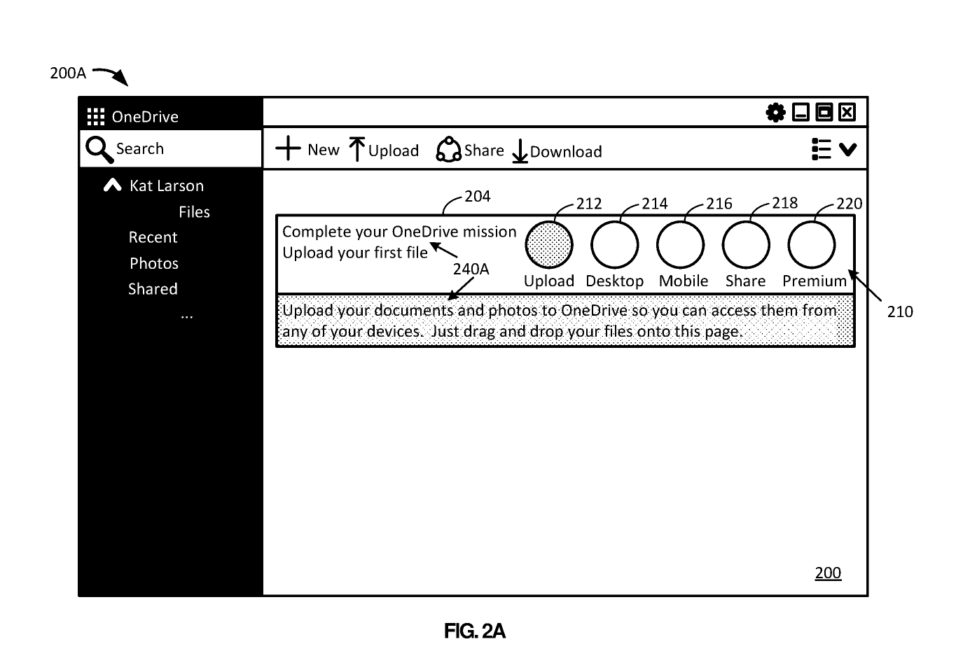

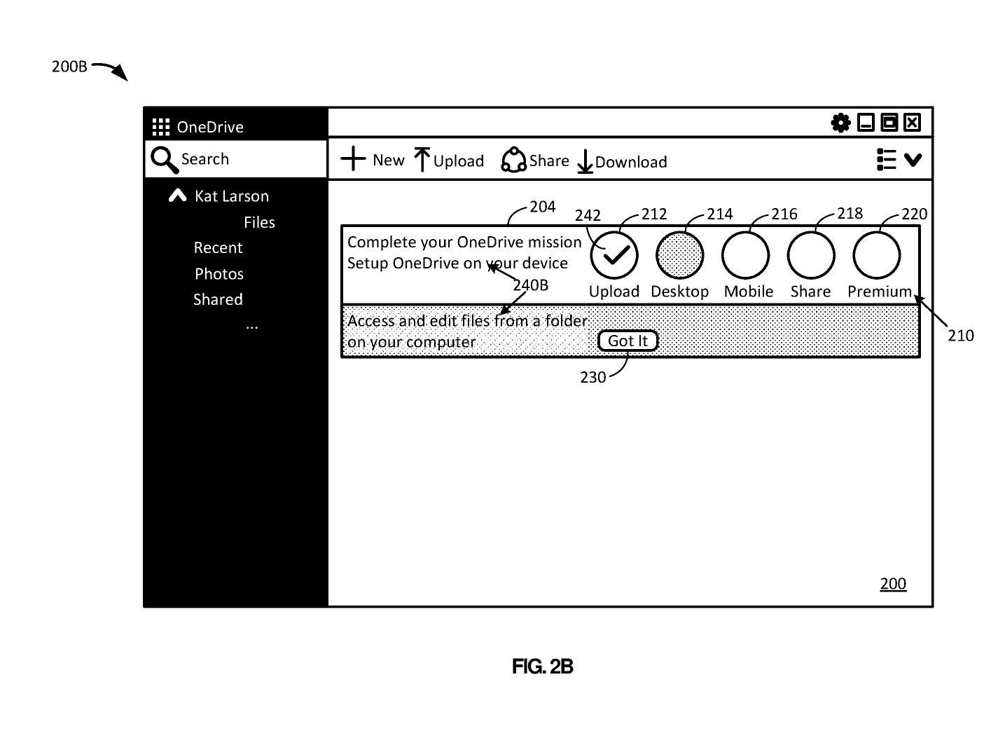

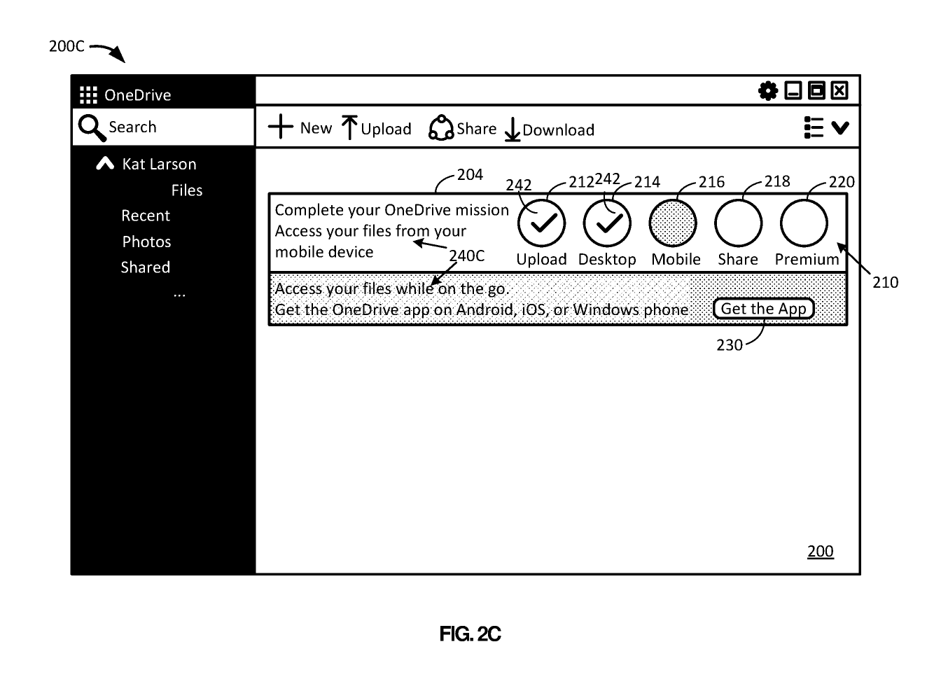

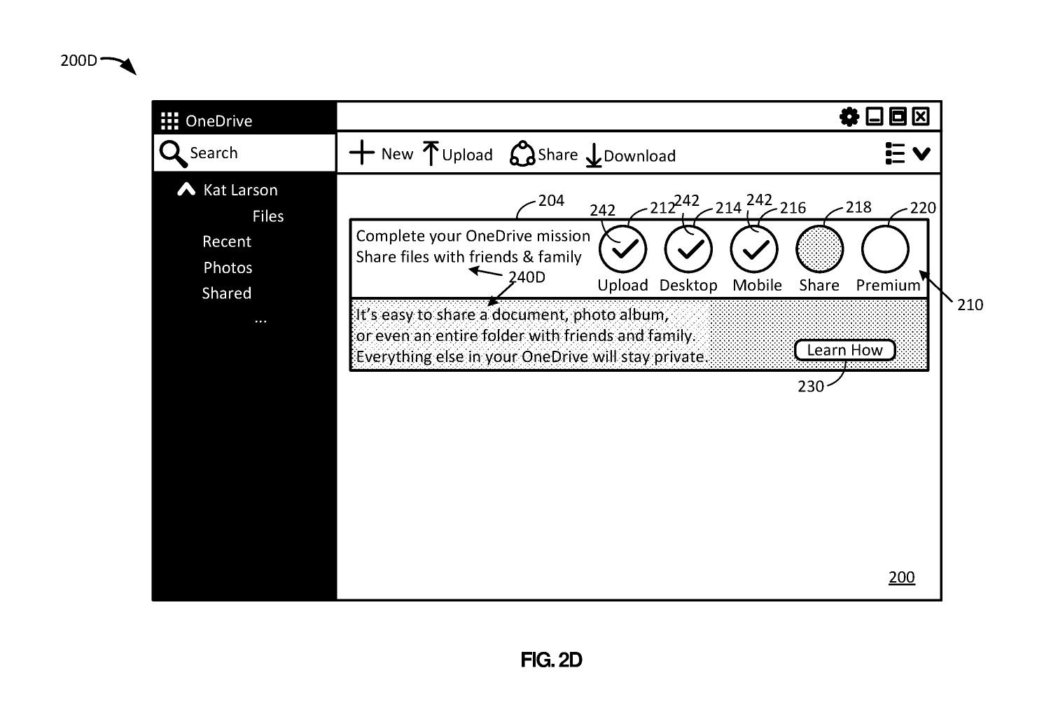

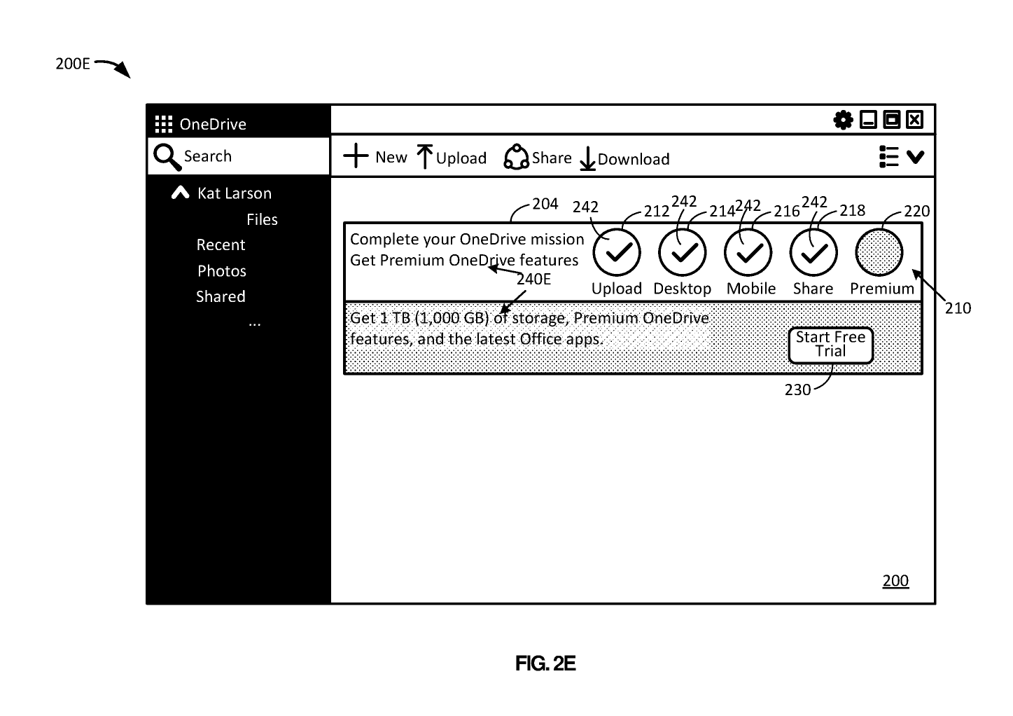

In some examples, the action control may be presented as a single region within the application. For example, the application may include at least one of a mobile application, a sync client, and a web application. In one example, when the application is a web application (e.g., a user may access the application service 106 via the web application), the action control may be presented as a single region within the web application, which will be illustrated and described in more detail below relative to FIGS. 2A-2E. In this example, the action control may include most, if not all, of the plurality of actions displayed simultaneously within the single region of the web application. In another example, the action control may be presented as a series of user interface cards within the application. In one example, when the application is a mobile application (e.g., a user may download a mobile application on a mobile phone, for example, for accessing the application service 106 on the mobile phone), the action control may be presented as a series of user interface cards within the mobile application. In this example, the action control may include one action displayed within each user interface card within the mobile application. In this regard, a user may scroll through each user interface card to perform and/or complete each action. In another example, when the application is a sync client (e.g., a user may download a sync client on a desktop device and/or a tablet, for example, for accessing the application service 106), the action control may be presented as a single region or a series of user interface cards within the sync client.

While specific examples are described herein relative to presenting the action control within various types of applications for accessing the service application 106, it is appreciated that the action control may be presented in any way and/or in any combination of ways, including as a single region and a series of user interface cards, in any of the application types and/or any combination of the application types (e.g., web application, sync client, and mobile application).

In one example, the plurality of actions to be completed by a user navigating the application may include performing an upload, accessing a mobile application, accessing a sync client, sharing a file, and upgrading an account. In one example, preforming an upload may include uploading and/or adding any item, such as the items described herein, to the application service 106. In one case, performing an upload may be the first time an item is uploaded and/or added to the application service 106 by a user. In this regard, after uploading and/or adding an item to the application service 106, the performing an upload action may be identified as complete. In one example, an item may be uploaded by using any endpoint (e.g., any type of client computing device 104A-104B). For example, an item may be uploaded to the application service 106 using a mobile phone, a tablet device, and/or a desktop device. The mobile phone, tablet device, and desktop device may include any type of platform such as iOS®, Android®, MAC®, and Windows®. Furthermore, an item may be uploaded using any type of application described herein for accessing the application service 106 (e.g., via a mobile application, a sync client, and a web application).

In one example, accessing a mobile application may include downloading and opening a mobile application associated with the application service 106. For example, when the application service 106 is OneDrive, accessing a mobile application may include downloading and opening a OneDrive application. In one example, accessing the mobile application is performed on an endpoint such as a mobile phone or a tablet device. In this example, the action is associated with the endpoint on which the action is to be completed. That is, accessing a mobile application is an action that is completed using either a mobile phone or a tablet device. When the mobile application associated with the application service 106 is downloaded and opened using a mobile phone or a tablet device, the accessing a mobile application action may be identified as complete.

In one example, accessing a sync client may include downloading and setting up a sync client associated with the application service 106. In one example, when the application service 106 is OneDrive, accessing a sync client may include downloading and setting up a sync client integrated with OneDrive. For example, the sync client may be integrated with the file explorer of the endpoint for accessing files stored on the endpoint and/or application service 106. In one example, accessing the sync client is performed on an endpoint such as a desktop device or a tablet device. In this example, the action is associated with the endpoint on which the action is to be completed. That is, accessing a sync client is an action that is completed using either a desktop device or a tablet device. In this regard, a user is encouraged to get familiar with engaging and navigating the application across (e.g., using) multiple endpoints. In turn, a user may be more productive and efficient while navigating the application service 106 as the user may be familiar with which endpoint and/or application to use for specific tasks (e.g., uploading photos using the mobile application vs synchronizing files using the sync client). When the sync client associated with the application service 106 is downloaded and setup using a desktop device or a tablet device, the accessing a sync client action may be identified as complete.

In one example, sharing a file may include sharing any item, such as the items described herein, stored in the application service 106 and/or locally on the endpoint used to access the application service 106. In one case, sharing the file may be the first time an item is shared by a user. The item may be shared with any contacts associated with the user such as friends and family The sharing a file action may be performed and/or completed by selecting a link to share the item, inviting another user to edit the item, and giving another user access to an item such as a folder to add content to the item. In this regard, after sharing the file using any of the methods described herein, the sharing a file action may be identified as complete. In one example, an item may be shared by using any endpoint (e.g., any type of client computing device 104A-104B). For example, an item may be shared using a mobile phone, a tablet device, and/or a desktop device. The mobile phone, tablet device, and desktop device may include any type of platform such as iOS®, Android®, MAC®, and Windows®. Furthermore, an item may be shared using any type of application described herein for accessing the application service 106 (e.g., via a mobile application, a sync client, and a web application).

In one example, upgrading an account may include upgrading access to services offered by the application service 106. For example, when the application service 106 is OneDrive, upgrading an account may include purchasing premium services associated with OneDrive. In another example, upgrading an account may include purchasing 0365. In one example, when a user upgrades an account (e.g., upgrades to premium services), the upgrading an account action may be identified as complete. In another example, when a user accesses information associated with upgrading an account (e.g., by selecting the upgrading an account action within the action control), the upgrading an account action may be identified as complete. In one example, an account may be upgraded using any endpoint (e.g., any type of client computing device 104A-104B). For example, an account may be upgraded using a mobile phone, a tablet device, and/or a desktop device. The mobile phone, tablet device, and desktop device may include any type of platform such as iOS®, Android®, MAC®, and Windows®. Furthermore, an account may be upgraded using any type of application described herein for accessing the application service 106 (e.g., via a mobile application, a sync client, and a web application).

As described above, when a user performs/completes an action on one endpoint, the action may be identified and stored as complete. As such, when a user completes a first action on a first endpoint while navigating the application and launches, signs-in to, and/or logs-in to the application on a second endpoint, the action completed on the first endpoint may be identified and/or stored as complete. In one example, a visual indication may be displayed to indicate that an action has been completed, which will be illustrated and described relative to FIGS. 2A-2E. In this regard, at least a first action of the plurality of actions may be presented in the action control when the application is accessed by a first endpoint. Subsequent to the first action being completed, at least a second action may be presented in the action control when the application is accessed by a second endpoint. Subsequent to the second action being completed, at least a third action may be presented in the action control when the application is accessed by a third endpoint. Subsequent to the third action being completed, at least a fourth action may be presented in the action control when the application is accessed by a fourth endpoint. Subsequent to the fourth action being completed, at least a fifth action may be presented in the action control when the application is accessed by a fifth endpoint. In some examples, any number of actions may be presented in the action control within the application used to access the application service 106. In other examples, any number of actions may be presented in the action control within the application used to access the application service 106, before and/or subsequent to another action being completed.

In some examples, the endpoint on which the action is presented may be the same endpoint or a different endpoint on which a different action is presented. For example, the first endpoint, as described above, may be the same endpoint as the second endpoint, as described above. In another example, the third endpoint, as described above, may be the same endpoint as the fifth endpoint, as described above. In another example, the first endpoint, as described above, may be a different endpoint from the second endpoint, as described above. For example, the first endpoint may be a desktop device and the second endpoint may be a mobile phone.

In some examples, in addition to the next action to be completed by the user being presented, each action of the plurality of actions that have been completed by the user may be presented within the application. For example, each action of the plurality of actions that have been completed may include a visual indication to indicate that an action has been completed. In one example, presenting the next action to be completed by the user within the application may include highlighting the next action to be completed such that it appears selected. In some cases, when the next action to be completed by the user within the application is presented by highlighting the next action to be completed, an input corresponding to another action (e.g., an action that is not highlighted) to be completed may be received. For example, a user may choose to complete an action within the application that has not been presented by highlighting (e.g., encouraging the user to complete the presented action). As such, the user may select the action that the user chooses to complete next (e.g., rather than completing the next action presented to the user).

In one example, the user interface components 110A-110B may be a touchable user interface that is capable of receiving input via contact with a screen of the client computing devices 104A-104B, thereby functioning as both an input device and an output device. For example, content may be displayed, or output, on the screen of the client computing devices 104A-104B and input may be received by contacting the screen using a stylus or by direct physical contact of a user, e.g., touching the screen. Contact may include, for instance, tapping the screen, using gestures such as swiping or pinching the screen, sketching on the screen, etc.

In another example, the user interface components 110A-110B may be a non-touch user interface. In one case, a tablet device, for example, may be utilized as a non-touch device when it is docked at a docking station (e.g., the tablet device may include a non-touch user interface). In another case, a desktop computer may include a non-touch user interface. In this example, the non-touchable user interface may be capable of receiving input via contact with a screen of the client computing devices 104A-104B, thereby functioning as both an input device and an output device. For example, content may be displayed, or output, on the screen of the client computing devices 104A-104B and input may be received by contacting the screen using a cursor, for example. In this regard, contact may include, for example, placing a cursor on the non-touchable user interface using a device such as a mouse.

In some aspects, the application service 106 may include a storage platform 130 and a data store 140. In one example, the storage platform 130 may be configured to store, manage, and access data and/or information associated with the guided action system 100. For example, the storage platform 130 may store one or more user progression states corresponding to a plurality of actions, a plurality of actions to be completed by a user while using an application, and/or items and files associated with a dataset in the data store 140. In one example, data store 140 may be part of and/or located at the storage platform 130. In another example, data store 140 may be a separate component and/or may be located separate from the storage platform 130. It is appreciated that although one application service 106 is illustrated in FIG. 1, the guided action system 100 may include a plurality of application services 106 with a plurality of storage platforms 130 and a plurality of data stores 140. In some cases, the application service 106 may include a plurality of storage platforms 130 and a plurality of data stores 140. For example, the plurality of storage platforms 130 may include at least file storage providers, external activity services and document editing clients. In one example, the storage platform 130 and/or the application service 106 may be cloud storage services such as OneDrive, SharePoint, and the like.

The examples described herein are exemplary only and should not be considered as limiting. For example, while various datasets, items, files, applications, actions, user progression states and endpoints are described herein, it is appreciated that any number of datasets, items, files, applications, actions, user progression states and endpoints may be used for efficiently tracking user progress as a user navigates an application across multiple endpoints. Furthermore, any combination of the datasets, items, files, applications, actions, user progression states and endpoints described herein may be used for efficiently tracking user progress as a user navigates an application across multiple endpoints.

Referring now to FIG. 2A, one view 200A in a progression of views of an application 200 for efficiently tracking user progress as a user navigates an application across multiple endpoints is shown. The exemplary application 200, as shown in FIG. 2A, is a OneDrive web application. As illustrated in FIG. 2A, the view 200A of the exemplary application 200 includes an action control 204, a plurality of actions 210, and information 240A. The plurality of actions 210 include performing an upload 212, accessing a sync client 214, accessing a mobile application 216, sharing a file 218, and upgrading an account 220. As illustrated in FIG. 2A, the performing an upload action 212 is presented in the action control 204. For example, as shown in FIG. 2A, the performing an upload action 212 is highlighted. In one example, the performing an upload action 212 is presented when the application 200 is accessed by a first endpoint (e.g., one of the client computing devices 104A-104B). In another example, the performing an upload action 212 is presented when the application 200 is accessed by a second endpoint, a third endpoint, and the like. As illustrated in FIG. 2A, the action control 204 is presented as a single region within the application 200. In one example, the performing an upload action 212 is presented based on a predetermined order for presenting a plurality of actions to be completed by a user when using the application 200. For example, a user may be encouraged to perform one action of the plurality of actions 210 first. In one example, the performing an upload action 212 may be the first action of the plurality of actions 210 to be presented to the user for completing. In another example, the performing an upload action 212 may be presented when it is selected by a user for completing.

As illustrated in FIG. 2A, information 240A associated with the presented action may be displayed within the application 200. For example, the information 240A associated with the performing an upload action 212 may include information such as, “Complete your OneDrive Mission”, “Upload your first file”, and “Upload your documents and photos to OneDrive so you can access them from any of your devices. Just drag and drop your files onto this page”. As discussed herein, the performing an upload action 212 may include uploading and/or adding any item, such as the items described herein, to the application service 106. In one case, the performing an upload action 212 may be the first time an item is uploaded and/or added to the application service 106 by a user. In one example, an item may be uploaded by using any endpoint (e.g., any type of client computing device 104A-104B). For example, an item may be uploaded to the application service 106 using a mobile phone, a tablet device, and/or a desktop device. The mobile phone, tablet device, and desktop device may include any type of platform such as iOS®, Android®, MAC®, and Windows®. Furthermore, an item may be uploaded using any type of application described herein for accessing the application service 106 (e.g., via a mobile application, a sync client, and a web application).

FIG. 2B illustrates another view 200B in a progression of views of the application 200 for efficiently tracking user progress as a user navigates an application across multiple endpoints. As illustrated in FIG. 2B, the view 200B of the exemplary application 200 includes an action control 204, a plurality of actions 210, information 240B, and an action button 230. The plurality of actions 210 include performing an upload 212, accessing a sync client 214, accessing a mobile application 216, sharing a file 218, and upgrading an account 220. As illustrated in FIG. 2B, the performing an upload action 212 includes a visual indicator 242. As discussed herein, a visual indication (e.g., 242) may be displayed to indicate that an action has been completed. In this regard, after uploading and/or adding an item to the application service 106, the performing an upload action 212 may be identified as complete (e.g., via the visual indicator 242). In the example illustrated in FIG. 2B, the visual indicator 242 is a check mark. It is appreciated that any visual indicator 242 may be used to indicate that an action has been completed.

As illustrated in FIG. 2B, the accessing a sync client action 214 is presented in the action control 204. For example, as shown in FIG. 2B, the accessing a sync client action 214 is highlighted. In one example, the accessing a sync client action 214 is presented when the application 200 is accessed by a first endpoint (e.g., one of the client computing devices 104A-104B). In another example, the accessing a sync client action 214 is presented when the application 200 is accessed by a second endpoint, a third endpoint, and the like. As illustrated in FIG. 2B, the action control 204 is presented as a single region within the application 200. In one example, the accessing a sync client action 214 is presented based on a predetermined order for presenting a plurality of actions to be completed by a user when using the application 200. For example, a user may be encouraged to perform one action of the plurality of actions 210 based on a last presented action. In one example, the accessing a sync client action 214 may be presented based on the last presented action. For example, the accessing a sync client action 214 may be presented after the performing an upload action 212 is presented to a user for completing.

In another example, the accessing a sync client action 214 may be presented based on at least the endpoint on which the application 200 is accessed. For example, the accessing the sync client action 214 is performed on an endpoint such as a desktop device or a tablet device. In this example, the accessing the sync client action 214 is associated with the endpoint on which the action is to be completed. That is, the accessing a sync client action 214 may be presented to a user for completing when the application 200 is accessed using either a desktop device or a tablet device. In another example, the accessing the sync client action 214 is presented based on which actions of the plurality of actions 210 have been completed. For example, when the performing an upload action 212 has been completed, the accessing a sync client action 214 may be presented. In another example, when every action of the plurality of actions 210 has been completed, the accessing a sync client action 214 may be presented to a user for completing. In another example, the accessing a sync client action 214 may be presented when it is selected by a user for completing.

As illustrated in FIG. 2B, information 240B associated with the presented action may be displayed within the application 200. For example, the information 240B associated with the accessing a sync client action 214 may include information such as, “Complete your OneDrive Mission”, “Setup OneDrive on your device”, and “Access and edit files from a folder on your computer”. The action button 230 may be associated with the information 240B. For example, in response to receiving a selection of the action button 230, a user may be prompted to download and setup a sync client associated with the application service 106. As discussed herein, the accessing a sync client action 214 may include downloading and setting up a sync client associated with the application service 106. In one example, when the application service 106 is OneDrive, the accessing a sync client action 214 may include downloading and setting up a sync client integrated with OneDrive. For example, the sync client may be integrated with the file explorer of the endpoint for accessing files stored on the endpoint and/or application service 106.

FIG. 2C illustrates another view 200C in a progression of views of the application 200 for efficiently tracking user progress as a user navigates an application across multiple endpoints. As illustrated in FIG. 2C, the view 200C of the exemplary application 200 includes an action control 204, a plurality of actions 210, information 240C, and an action button 230. The plurality of actions 210 include performing an upload 212, accessing a sync client 214, accessing a mobile application 216, sharing a file 218, and upgrading an account 220. As illustrated in FIG. 2C, the performing an upload action 212 and the accessing a sync client action 214 include a visual indicator 242. As discussed herein, a visual indication (e.g., 242) may be displayed to indicate that an action has been completed. In this regard, after uploading and/or adding an item to the application service 106, the performing an upload action 212 may be identified as complete (e.g., via the visual indicator 242). In another example, when the sync client associated with the application service 106 is downloaded and setup using a desktop device or a tablet device, the accessing a sync client action 214 may be identified as complete (e.g., via the visual indicator 242). In the example illustrated in FIG. 2C, the visual indicator 242 is a check mark. It is appreciated that any visual indicator 242 may be used to indicate that an action has been completed.

As illustrated in FIG. 2C, the accessing a mobile application action 216 is presented in the action control 204. For example, as shown in FIG. 2C, the accessing a mobile application action 216 is highlighted. In one example, the accessing a mobile application action 216 is presented when the application 200 is accessed by a first endpoint (e.g., one of the client computing devices 104A-104B). In another example, the accessing a mobile application action 216 is presented when the application 200 is accessed by a second endpoint, a third endpoint, and the like. As illustrated in FIG. 2C, the action control 204 is presented as a single region within the application 200. In one example, the accessing a mobile application action 216 is presented based on a predetermined order for presenting a plurality of actions to be completed by a user when using the application 200. For example, a user may be encouraged to perform one action of the plurality of actions 210 based on a last presented action. In one example, the accessing a mobile application action 216 may be presented based on the last presented action. For example, the accessing a mobile application action 216 may be presented after the accessing a sync client action 214 is presented to a user for completing.

In another example, the accessing a mobile application action 216 may be presented based on at least the endpoint on which the application 200 is accessed. For example, the accessing a mobile application action 216 is performed on an endpoint such as a mobile phone or a tablet device. In this example, the accessing a mobile application action 216 is associated with the endpoint on which the action is to be completed. That is, the accessing a mobile application action 216 may be presented to a user for completing when the application 200 is accessed using either a mobile phone or a tablet device. In another example, the accessing a mobile application action 216 is presented based on which actions of the plurality of actions 210 have been completed. For example, when the accessing a sync client action 214 has been completed, the accessing a mobile application action 216 may be presented. In another example, when every action of the plurality of actions 210 has been completed, the accessing a mobile application action 216 may be presented to a user for completing. In another example, the accessing a mobile application action 216 may be presented when it is selected by a user for completing.

As illustrated in FIG. 2C, information 240C associated with the presented action may be displayed within the application 200. For example, the information 240C associated with the accessing a mobile application action 216 may include information such as, “Complete your OneDrive Mission”, “Access your files from your mobile device”, and “Access your files while on the go. Get the OneDrive app on Android®, iOS®, or Windows phone”. The action button 230 may be associated with the information 240C. For example, in response to receiving a selection of the action button 230, a user may be prompted to download and open a mobile application associated with the application service 106. As discussed herein, the accessing a mobile application action 216 may include downloading and opening a mobile application associated with the application service 106. For example, when the application service 106 is OneDrive, the accessing a mobile application action 216 may include downloading and opening a OneDrive application.

FIG. 2D illustrates another view 200D in a progression of views of the application 200 for efficiently tracking user progress as a user navigates an application across multiple endpoints. As illustrated in FIG. 2D, the view 200D of the exemplary application 200 includes an action control 204, a plurality of actions 210, information 240D, and an action button 230. The plurality of actions 210 include performing an upload 212, accessing a sync client 214, accessing a mobile application 216, sharing a file 218, and upgrading an account 220. As illustrated in FIG. 2D, the performing an upload action 212, the accessing a sync client action 214, and the accessing a mobile application action 216 include a visual indicator 242. As discussed herein, a visual indication (e.g., 242) may be displayed to indicate that an action has been completed. In this regard, after uploading and/or adding an item to the application service 106, the performing an upload action 212 may be identified as complete (e.g., via the visual indicator 242). In another example, when the sync client associated with the application service 106 is downloaded and setup using a desktop device or a tablet device, the accessing a sync client action 214 may be identified as complete (e.g., via the visual indicator 242). In another example, when the mobile application associated with the application service 106 is downloaded and opened using a mobile phone or a tablet device, the accessing a mobile application action may be identified as complete (e.g., via the visual indicator 242). In the example illustrated in FIG. 2D, the visual indicator 242 is a check mark. It is appreciated that any visual indicator 242 may be used to indicate that an action has been completed.

As illustrated in FIG. 2D, the sharing a file action 218 is presented in the action control 204. For example, as shown in FIG. 2D, the sharing a file action 218 is highlighted. In one example, the sharing a file action 218 is presented when the application 200 is accessed by a first endpoint (e.g., one of the client computing devices 104A-104B). In another example, the sharing a file action 218 is presented when the application 200 is accessed by a second endpoint, a third endpoint, and the like. As illustrated in FIG. 2D, the action control 204 is presented as a single region within the application 200. In one example, the sharing a file action 218 is presented based on a predetermined order for presenting a plurality of actions to be completed by a user when using the application 200. For example, a user may be encouraged to perform one action of the plurality of actions 210 based on a last presented action. In one example, the sharing a file action 218 may be presented based on the last presented action. For example, the sharing a file action 218 may be presented after the accessing a mobile application action 216 is presented to a user for completing.

In another example, the sharing a file action 218 is presented based on which actions of the plurality of actions 210 have been completed. For example, when the accessing a mobile application action 216 has been completed, sharing a file action 218 may be presented. In another example, when every action of the plurality of actions 210 has been completed, the sharing a file action 218 may be presented to a user for completing. In another example, the sharing a file action 218 may be presented when it is selected by a user for completing. As illustrated in FIG. 2D, information 240D associated with the presented action may be displayed within the application 200. For example, the information 240D associated with the sharing a file action 218 may include information such as, “Complete your OneDrive Mission”, “Share files with friends and family”, and “It's easy to share a document, photo album, or even an entire folder with friends and family Everything else in your OneDrive will stay private”. The action button 230 may be associated with the information 240D. For example, in response to receiving a selection of the action button 230, a user may be presented with information regarding how to share an item.

As discussed herein, the sharing a file action 218 may include sharing any item, such as the items described herein, stored in the application service 106 and/or locally on the endpoint used to access the application service 106. In one case, sharing the file may be the first time an item is shared by a user. The item may be shared with any contacts associated with the user such as friends and family The sharing a file action 218 may be performed and/or completed by selecting a link to share the item, inviting another user to edit the item, and giving another user access to an item such as a folder to add content to the item. In one example, an item may be shared by using any endpoint (e.g., any type of client computing device 104A-104B). For example, an item may be shared using a mobile phone, a tablet device, and/or a desktop device. The mobile phone, tablet device, and desktop device may include any type of platform such as iOS®, Android®, MAC®, and Windows®. Furthermore, an item may be shared using any type of application described herein for accessing the application service 106 (e.g., via a mobile application, a sync client, and a web application).

FIG. 2E illustrates another view 200E in a progression of views of the application 200 for efficiently tracking user progress as a user navigates an application across multiple endpoints. As illustrated in FIG. 2E, the view 200E of the exemplary application 200 includes an action control 204, a plurality of actions 210, information 240E, and an action button 230. The plurality of actions 210 include performing an upload 212, accessing a sync client 214, accessing a mobile application 216, sharing a file 218, and upgrading an account 220. As illustrated in FIG. 2E, the performing an upload action 212, the accessing a sync client action 214, the accessing a mobile application action 216, and the sharing a file action 218 include a visual indicator 242. As discussed herein, a visual indication (e.g., 242) may be displayed to indicate that an action has been completed. In this regard, after uploading and/or adding an item to the application service 106, the performing an upload action 212 may be identified as complete (e.g., via the visual indicator 242). In another example, when the sync client associated with the application service 106 is downloaded and setup using a desktop device or a tablet device, the accessing a sync client action 214 may be identified as complete (e.g., via the visual indicator 242). In another example, when the mobile application associated with the application service 106 is downloaded and opened using a mobile phone or a tablet device, the accessing a mobile application action may be identified as complete (e.g., via the visual indicator 242). In another example, when a file is shared using any of the methods described herein, the sharing a file action 218 may be identified as complete (e.g., via the visual indicator 242). In the example illustrated in FIG. 2E, the visual indicator 242 is a check mark. It is appreciated that any visual indicator 242 may be used to indicate that an action has been completed.

As illustrated in FIG. 2E, the upgrading an account action 220 is presented in the action control 204. For example, as shown in FIG. 2E, the upgrading an account action 220 is highlighted. In one example, the upgrading an account action 220 is presented when the application 200 is accessed by a first endpoint (e.g., one of the client computing devices 104A-104B). In another example, the upgrading an account action 220 is presented when the application 200 is accessed by a second endpoint, a third endpoint, and the like. As illustrated in FIG. 2E, the action control 204 is presented as a single region within the application 200. In one example, the upgrading an account action 220 is presented based on a predetermined order for presenting a plurality of actions to be completed by a user when using the application 200. For example, a user may be encouraged to perform one action of the plurality of actions 210 based on a last presented action. In one example, the upgrading an account action 220 may be presented based on the last presented action. For example, the upgrading an account action 220 may be presented after the sharing a file action 218 is presented to a user for completing.

In another example, the upgrading an account action 220 is presented based on which actions of the plurality of actions 210 have been completed. For example, when the sharing a file action 218 has been completed, the upgrading an account action 220 may be presented. In another example, when every action of the plurality of actions 210 has been completed, the upgrading an account action 220 may be presented to a user for completing. In another example, the upgrading an account action 220 may be presented when it is selected by a user for completing. As illustrated in FIG. 2E, information 240E associated with the presented action may be displayed within the application 200. For example, the information 240E associated with the upgrading an account action 220 may include information such as, “Complete your OneDrive Mission”, “Get Premium OneDrive features”, and “Get 1 TB (1,000 GB) of storage, Premium OneDrive features, and the latest Office Apps”. The action button 230 may be associated with the information 240E. For example, in response to receiving a selection of the action button 230, a user may be presented with information regarding how to start a free trial of an upgraded account and/or how to upgrade access to services offered by the application service 106.

As discussed herein, the upgrading an account action 220 may include upgrading access to services offered by the application service 106. For example, when the application service 106 is OneDrive, the upgrading an account action 220 may include purchasing premium services associated with OneDrive. In another example, the upgrading an account action 220 may include purchasing 0365. In one example, when a user upgrades an account (e.g., upgrades to premium services), the upgrading an account action 220 may be identified as complete. In another example, when a user accesses information associated with upgrading an account (e.g., by selecting the upgrading an account action within the action control), the upgrading an account action 220 may be identified as complete. In one example, an account may be upgraded using any endpoint (e.g., any type of client computing device 104A-104B). For example, an account may be upgraded using a mobile phone, a tablet device, and/or a desktop device. The mobile phone, tablet device, and desktop device may include any type of platform such as iOS®, Android®, MAC®, and Windows®. Furthermore, an account may be upgraded using any type of application described herein for accessing the application service 106 (e.g., via a mobile application, a sync client, and a web application). In one example, the upgrading an account action 220 may include a visual indicator (e.g., 242) to indicate that the upgrading an account action 220 is complete (not illustrated).

While the present disclosure discusses views 200A-200E, application 200, action control 204, the plurality of actions 210, information 240A-240E, the action button 230, the performing an upload action 212, the accessing a sync client action 214, the accessing a mobile application action 216, the sharing a file action 218, and the upgrading an account action 220, visual indicator 242 and various methods for presenting the plurality of actions 210, this is only exemplary and should not be considered limiting. Any number of views, applications, action controls, actions, information, action buttons, and visual indicators may be utilized in conjunction with the present disclosure. For example, the information associated with the presented action may be different according the endpoint used to access the application. For example, when the application is accessed using a MAC® platform, the information displayed for a presented action may be different from the information displayed for a presented action when the application is accessed using a Windows platform.

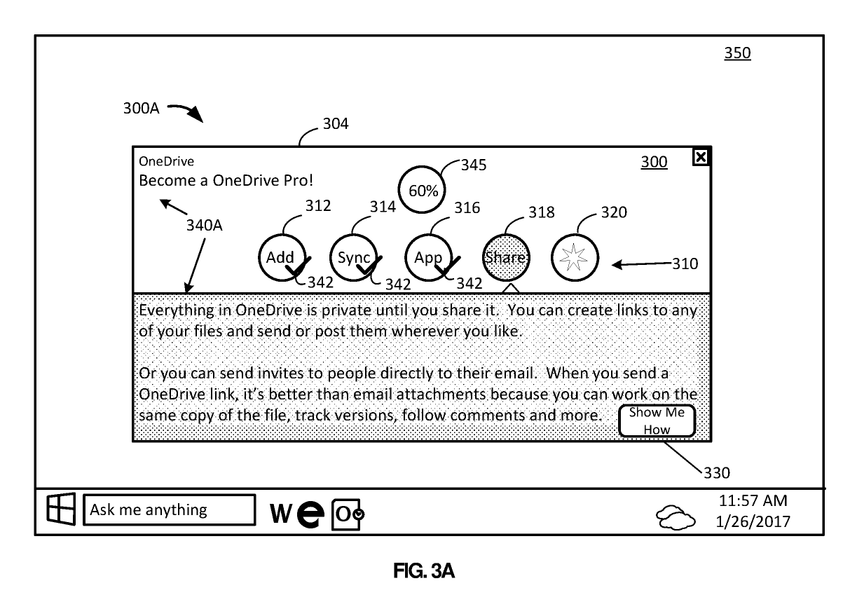

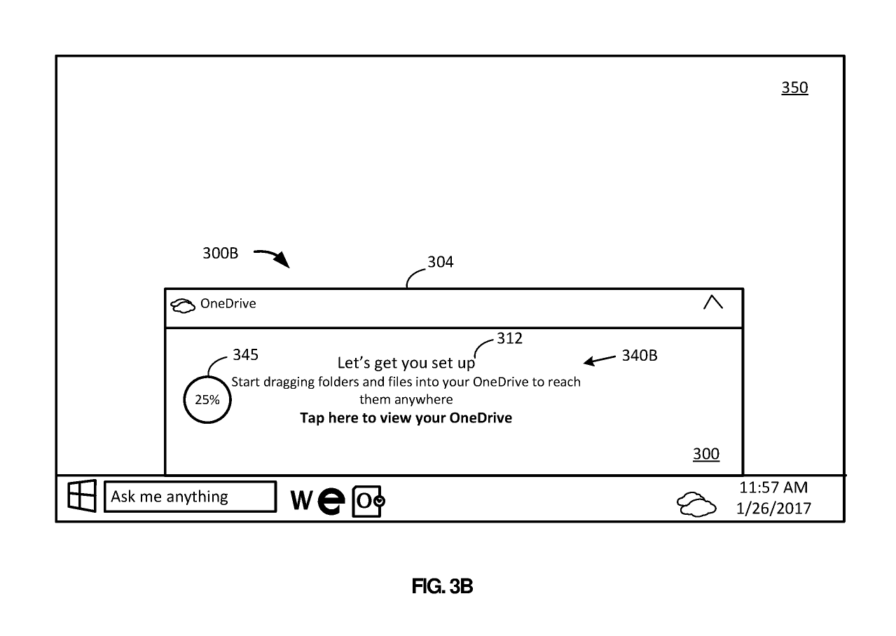

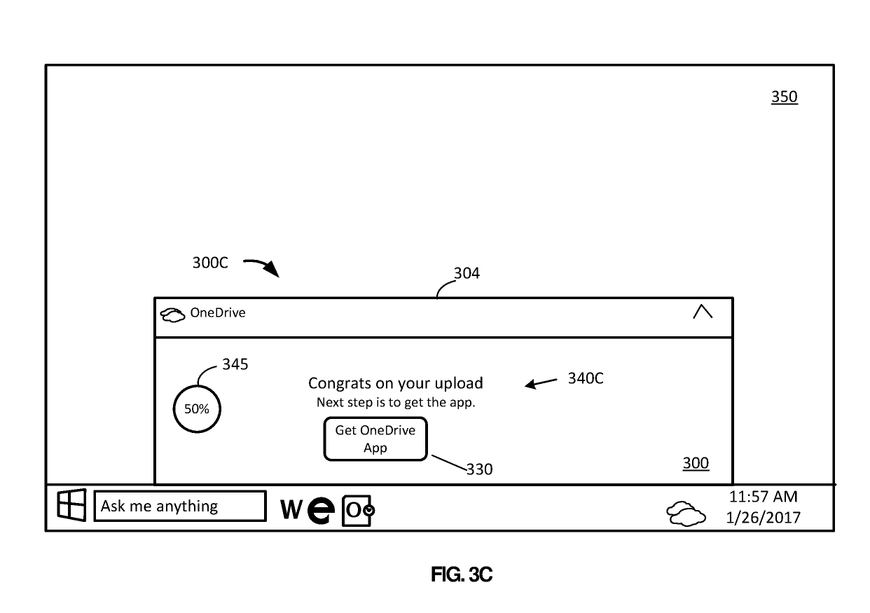

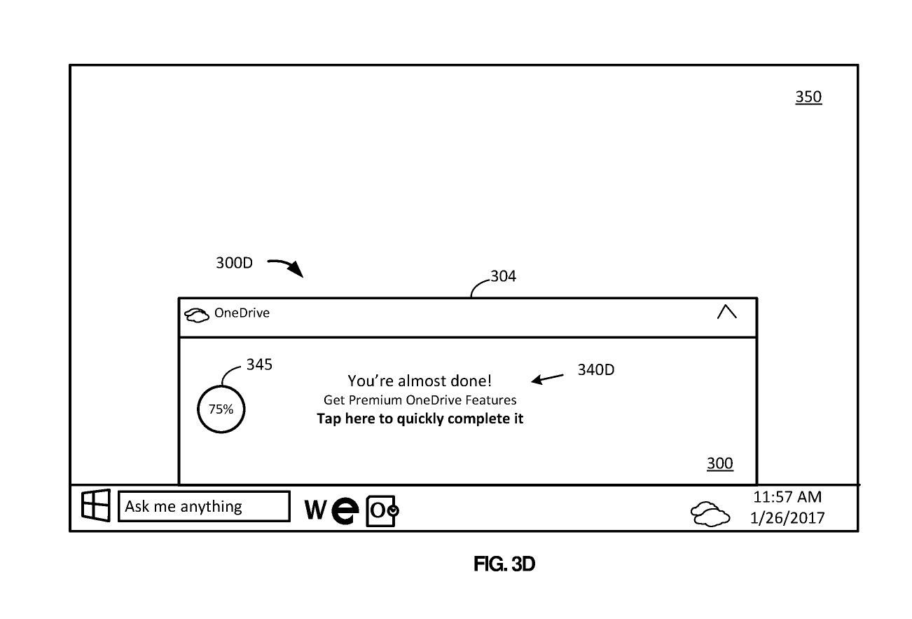

Referring now to FIG. 3A, one view 300A in a progression of views of an application 300 displayed in a user interface 350 for efficiently tracking user progress as a user navigates an application across multiple endpoints is shown. The exemplary application 300, as shown in FIG. 3A, is a OneDrive sync client. As illustrated in FIG. 3A, the view 300A of the exemplary application 300 includes an action control 304, a plurality of actions 310, information 340A, a completion indicator 345, and an action button 330. The plurality of actions 310 include performing an upload 312, accessing a sync client 314, accessing a mobile application 316, sharing a file 318, and upgrading an account 320. As illustrated in FIG. 3A, the performing an upload action 312, the accessing a sync client action 314, and the accessing a mobile application action 316 include a visual indicator 342. As discussed herein, a visual indication (e.g., 342) may be displayed to indicate that an action has been completed. In this regard, after uploading and/or adding an item to the application service 106, the performing an upload action 312 may be identified as complete (e.g., via the visual indicator 342). In another example, when the sync client associated with the application service 106 is downloaded and setup using a desktop device or a tablet device, the accessing a sync client action 314 may be identified as complete (e.g., via the visual indicator 342). In another example, when the mobile application associated with the application service 106 is downloaded and opened using a mobile phone or a tablet device, the accessing a mobile application action may be identified as complete (e.g., via the visual indicator 342). In the example illustrated in FIG. 3A, the visual indicator 342 is a check mark. It is appreciated that any visual indicator 342 may be used to indicate that an action has been completed.

As illustrated in FIG. 3A, the sharing a file action 318 is presented in the action control 304. For example, as shown in FIG. 3A, the sharing a file action 318 is highlighted. In one example, the sharing a file action 318 is presented when the application 300 is accessed by a first endpoint (e.g., one of the client computing devices 104A-104B). In another example, the sharing a file action 318 is presented when the application 300 is accessed by a second endpoint, a third endpoint, and the like. As illustrated in FIG. 3A, the action control 304 is presented as a single region within the application 300. In one example, the sharing a file action 318 is presented based on a predetermined order for presenting a plurality of actions to be completed by a user when using the application 300. For example, a user may be encouraged to perform one action of the plurality of actions 310 based on a last presented action. In one example, the sharing a file action 318 may be presented based on the last presented action. For example, the sharing a file action 318 may be presented after the accessing a mobile application action 316 is presented to a user for completing.

In another example, the sharing a file action 318 is presented based on which actions of the plurality of actions 310 have been completed. For example, when the accessing a mobile application action 316 has been completed, sharing a file action 318 may be presented. In another example, when every action of the plurality of actions 310 has been completed, the sharing a file action 318 may be presented to a user for completing. In another example, the sharing a file action 318 may be presented when it is selected by a user for completing. As illustrated in FIG. 3A, information 340A associated with the presented action may be displayed within the application 300. For example, the information 340A associated with the sharing a file action 318 may include information related to sharing an item, a file, a folder, and the like. The action button 330 may be associated with the information 340A. For example, in response to receiving a selection of the action button 330, a user may be presented with information regarding how to share an item. In one example, the completion indicator 345 may provide an indication of how far along a user is with respect to completing the plurality of actions 310. In the example illustrated in FIG. 3A, the user has completed 60% of the plurality of actions 310.

As discussed herein, the sharing a file action 318 may include sharing any item, such as the items described herein, stored in the application service 106 and/or locally on the endpoint used to access the application service 106. In one case, sharing the file may be the first time an item is shared by a user. The item may be shared with any contacts associated with the user such as friends and family The sharing a file action 318 may be performed and/or completed by selecting a link to share the item, inviting another user to edit the item, and giving another user access to an item such as a folder to add content to the item. In one example, an item may be shared by using any endpoint (e.g., any type of client computing device 104A-104B). For example, an item may be shared using a mobile phone, a tablet device, and/or a desktop device. The mobile phone, tablet device, and desktop device may include any type of platform such as iOS®, Android®, MAC®, and Windows®. Furthermore, an item may be shared using any type of application described herein for accessing the application service 106 (e.g., via a mobile application, a sync client, and a web application).

FIG. 3B illustrates another view 300B in a progression of views of the application 300 displayed in the user interface 350 for efficiently tracking user progress as a user navigates an application across multiple endpoints. As illustrated in FIG. 3B, the view 300B of the exemplary application 300 includes an action control 304, the performing an upload action 312, the completion indicator 345, and information 340B. In the example of FIG. 3B, the action control 304 is presented as a first card in a series of user interface cards within the application 300 (e.g., the sync client). In this regard, the performing an upload action 312 is presented as a first card in series of user interface cards. In one example, the performing an upload action 312 is presented when the application 300 is accessed by a first endpoint (e.g., one of the client computing devices 104A-104B). In another example, the performing an upload action 312 is presented when the application 300 is accessed by a second endpoint, a third endpoint, and the like. In one example, the performing an upload action 312 is presented based on a predetermined order for presenting a plurality of actions to be completed by a user when using the application 300. For example, a user may be encouraged to perform one action of the plurality of actions 310 first. In one example, the performing an upload action 312 may be the first action of the plurality of actions 310 to be presented to the user for completing. For example, the performing an upload action 312 is presented as the first card in a series of user interface cards. In another example, the performing an upload action 312 may be presented when it is selected by a user for completing.

As illustrated in FIG. 3B, information 340B associated with the presented action may be displayed within the application 300. For example, the information 340B associated with the performing an upload action 312 may include information such as, “Let's get you set up. Start dragging folders and files into your OneDrive to reach them anywhere. Tap here to view your OneDrive”. In one example, the completion indicator 345 may provide an indication of how far along a user is with respect to completing the plurality of actions 310. In the example illustrated in FIG. 3B, the user has completed 25% of the plurality of actions 310. As discussed herein, the performing an upload action 312 may include uploading and/or adding any item, such as the items described herein, to the application service 106. In one case, the performing an upload action 312 may be the first time an item is uploaded and/or added to the application service 106 by a user. In one example, an item may be uploaded by using any endpoint (e.g., any type of client computing device 104A-104B). For example, an item may be uploaded to the application service 106 using a mobile phone, a tablet device, and/or a desktop device. The mobile phone, tablet device, and desktop device may include any type of platform such as iOS®, Android®, MAC®, and Windows®. Furthermore, an item may be uploaded using any type of application described herein for accessing the application service 106 (e.g., via a mobile application, a sync client, and a web application).

FIG. 3C illustrates another view 300C in a progression of views of the application 300 displayed in the user interface 350 for efficiently tracking user progress as a user navigates an application across multiple endpoints. As illustrated in FIG. 3C, the view 300C of the exemplary application 300 includes an action control 304, the accessing a mobile application action 316, the completion indicator 345, information 340C, and the action button 330. In the example of FIG. 3C, the action control 304 is presented as a second card in a series of user interface cards within the application 300 (e.g., the sync client). In this regard, the accessing a mobile application action 316 is presented as a second card in series of user interface cards. In one example, the accessing a mobile application action 316 is presented when the application 300 is accessed by a first endpoint (e.g., one of the client computing devices 104A-104B). In another example, the accessing a mobile application action 316 is presented when the application 300 is accessed by a second endpoint, a third endpoint, and the like. In one example, the accessing a mobile application action 316 is presented based on a predetermined order for presenting a plurality of actions to be completed by a user when using the application 300. For example, a user may be encouraged to perform one action of the plurality of actions 310 based on a last presented action. In one example, the accessing a mobile application action 316 may be presented based on the last presented action. For example, the accessing a mobile application action 316 may be presented after the accessing a sync client action 314 is presented to a user for completing.

In another example, the accessing a mobile application action 316 may be presented based on at least the endpoint on which the application 300 is accessed. For example, the accessing a mobile application action 316 is performed on an endpoint such as a mobile phone or a tablet device. In this example, the accessing a mobile application action 316 is associated with the endpoint on which the action is to be completed. That is, the accessing a mobile application action 316 may be presented to a user for completing when the application 300 is accessed using either a mobile phone or a tablet device. In another example, the accessing a mobile application action 316 is presented based on which actions of the plurality of actions 310 have been completed. For example, when the accessing a sync client action 314 has been completed, the accessing a mobile application action 316 may be presented. In another example, when every action of the plurality of actions 310 has been completed, the accessing a mobile application action 316 may be presented to a user for completing. In another example, the accessing a mobile application action 316 may be presented when it is selected by a user for completing.

As illustrated in FIG. 3C, information 340C associated with the presented action may be displayed within the application 300. For example, the information 340C associated with the accessing a mobile application action 316 may include information such as, “Congrats on your upload. Next step is to get the app”. The action button 330 may be associated with the information 340C. For example, in response to receiving a selection of the action button 330, a user may be prompted to download and open a mobile application associated with the application service 106. In one example, the completion indicator 345 may provide an indication of how far along a user is with respect to completing the plurality of actions 310. In the example illustrated in FIG. 3C, the user has completed 50% of the plurality of actions 310. As discussed herein, the accessing a mobile application action 316 may include downloading and opening a mobile application associated with the application service 106. For example, when the application service 106 is OneDrive, the accessing a mobile application action 316 may include downloading and opening a OneDrive application.

FIG. 3D illustrates another view 300D in a progression of views of the application 300 displayed in the user interface 350 for efficiently tracking user progress as a user navigates an application across multiple endpoints. As illustrated in FIG. 3D, the view 300D of the exemplary application 300 includes an action control 304, the upgrading an account action 320, the completion indicator 345, and information 340D. In the example of FIG. 3D, the action control 304 is presented as a third card in a series of user interface cards within the application 300 (e.g., the sync client). In this regard, the accessing a mobile application action 320 is presented as a third card in series of user interface cards. In one example, the upgrading an account action 320 is presented when the application 300 is accessed by a first endpoint (e.g., one of the client computing devices 104A-104B). In another example, the upgrading an account action 320 is presented when the application 300 is accessed by a second endpoint, a third endpoint, and the like. In one example, the upgrading an account action 320 is presented based on a predetermined order for presenting a plurality of actions to be completed by a user when using the application 300. For example, a user may be encouraged to perform one action of the plurality of actions 310 based on a last presented action. In one example, the upgrading an account action 320 may be presented based on the last presented action. For example, the upgrading an account action 320 may be presented after the sharing a file action 318 is presented to a user for completing.

In another example, the upgrading an account action 320 is presented based on which actions of the plurality of actions 310 have been completed. For example, when the sharing a file action 318 has been completed, the upgrading an account action 320 may be presented. In another example, when every action of the plurality of actions 310 has been completed, the upgrading an account action 320 may be presented to a user for completing. In another example, the upgrading an account action 320 may be presented when it is selected by a user for completing. As illustrated in FIG. 3D, information 340D associated with the presented action may be displayed within the application 300. For example, the information 340D associated with the upgrading an account action 320 may include information such as, “You're almost done! Get Premium OneDrive Features. Tap here to quickly complete it”. In one example, the completion indicator 345 may provide an indication of how far along a user is with respect to completing the plurality of actions 310. In the example illustrated in FIG. 3D, the user has completed 75% of the plurality of actions 310.

As discussed herein, the upgrading an account action 320 may include upgrading access to services offered by the application service 106. For example, when the application service 106 is OneDrive, the upgrading an account action 320 may include purchasing premium services associated with OneDrive. In another example, the upgrading an account action 320 may include purchasing 0365. In one example, when a user upgrades an account (e.g., upgrades to premium services), the upgrading an account action 320 may be identified as complete. In another example, when a user accesses information associated with upgrading an account (e.g., by selecting the upgrading an account action within the action control), the upgrading an account action 320 may be identified as complete. In one example, an account may be upgraded using any endpoint (e.g., any type of client computing device 104A-104B). For example, an account may be upgraded using a mobile phone, a tablet device, and/or a desktop device. The mobile phone, tablet device, and desktop device may include any type of platform such as iOS®, Android®, MAC®, and Windows®. Furthermore, an account may be upgraded using any type of application described herein for accessing the application service 106 (e.g., via a mobile application, a sync client, and a web application).

While the present disclosure discusses views 300A-300D, application 300, action control 304, the plurality of actions 310, information 340A-340D, the action button 330, the performing an upload action 312, the accessing a sync client action 314, the accessing a mobile application action 316, the sharing a file action 318, and the upgrading an account action 320, visual indicator 342, completion indicator 345 and various methods for presenting the plurality of actions 310, this is only exemplary and should not be considered limiting. Any number of views, applications, action controls, actions, information, action buttons, visual indicators, and completion indicators may be utilized in conjunction with the present disclosure.

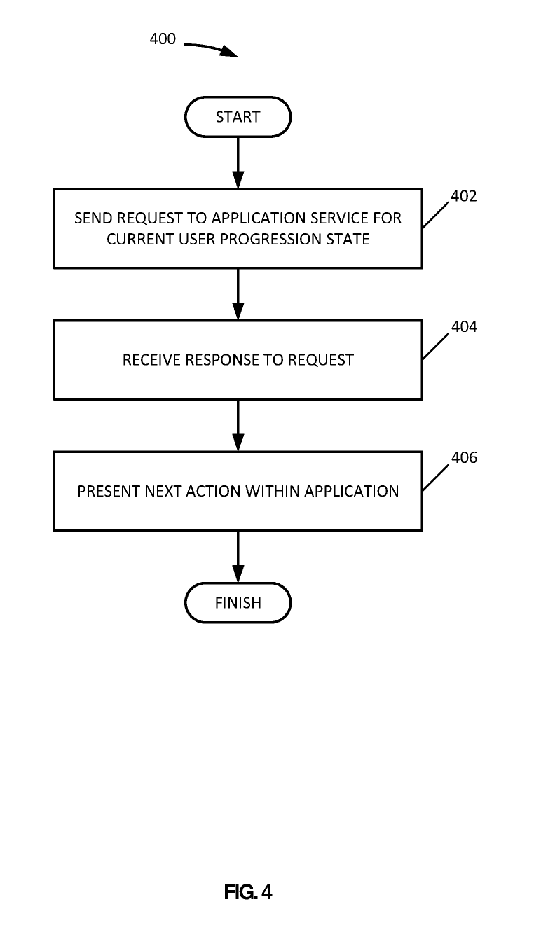

Referring now to FIG. 4, an exemplary method 400 for facilitating user progress while navigating an application, according to an example aspect is shown. Method 400 may be implemented on a computing device or a similar electronic device capable of executing instructions through at least one processor. Method 400 may begin at operation 402, where a request may be sent to an application service associated with the application for a current user progression state corresponding to an action of a plurality of actions to be completed by a user while using the application. In one example, the current user progression state may indicate a status of a user with regard to completing the plurality of actions to be completed while using the application. For example, the current user progression state may indicate the number of actions and/or type of actions that have already been completed by the user. In this regard, the current user progression state corresponding to an action of the plurality of actions to be completed by a user while using the application may correspond to at least the last completed action by the user and/or the next action to be completed by the user. In one example, the application service may include cloud storage services such as OneDrive, SharePoint, and the like.

When a request is sent to an application service associated with the application for a current user progression state corresponding to an action of a plurality of actions to be completed by a user while using the application, flow proceeds to operation 404 where a response to the request may be received. In one example, the response includes at least a next action of the plurality of actions to be completed by the user. In one example, the next action of the plurality of actions to be completed by the user may be based on a last presented action. For example, a predetermined order may be determined for presenting the plurality of actions to be completed by a user when using the application. In this example, the next action of the plurality of actions to be completed by the user may include the action in the predetermined order that comes after the last presented action. In another example, the next action of the plurality of actions to be completed by the user may include the action in the predetermined order that comes after the last completed action. In another example, the next action of the plurality of actions to be completed by the user may be based on at least the endpoint on which the application is accessed and/or which actions of the plurality of actions have been completed. For example, when a user accesses the application with a mobile phone, the next action to be completed by the user may be based on accessing the application with a mobile phone. In this case, the next action to be completed by the user may include accessing a mobile application.

When a response to the request is received, flow proceeds to operation 406 where at least the next action of the plurality of actions to be completed by the user is presented within the application in a user interface of an endpoint. In one example, presenting the next action to be completed by the user within the application includes highlighting the next action to be completed such that it appears selected. In this regard, the user is encouraged to complete the next action. In some examples, in addition to presenting the next action to be completed by the user, each action of the plurality of actions that have been completed by the user may be presented within the application. In some examples, in addition to presented the next action to be completed by the user and the actions that have been completed by the user, the actions that have not been completed may be presented within the application. In some examples, the plurality of actions to be completed by the user may be presented within the application in the user interface of another endpoint. In some examples, an input corresponding to an action of the plurality of actions to be completed may be received on the endpoint and/or the another endpoint. In this example, the action that receives the input may be completed by the user. In one example, at least one action of the plurality of actions is associated with an endpoint on which the action is to be completed. In this regard, a user may become efficient with the application and/or application service with all endpoints on which the application and/or application service may be accessed.

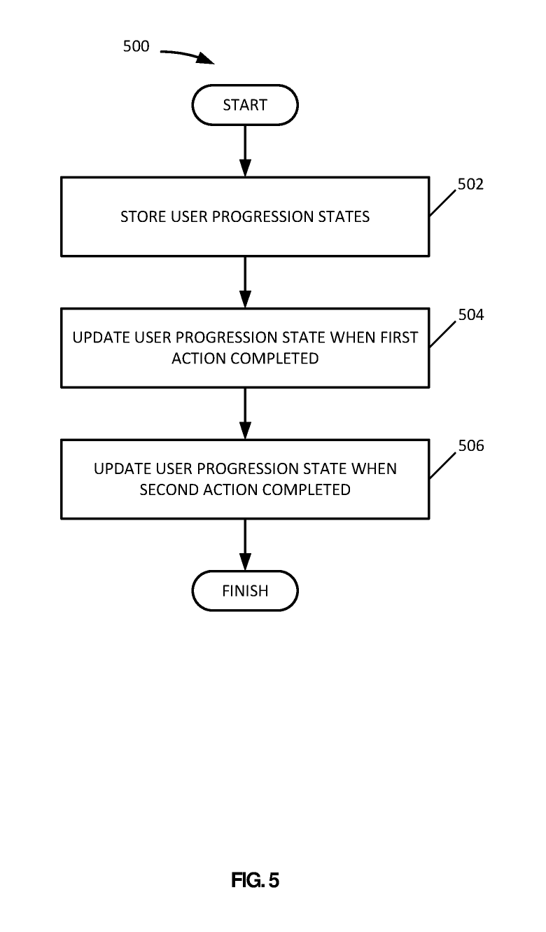

Referring now to FIG. 5, an exemplary method 500 for tracking user progression states of an application across multiple endpoints, according to an example aspect is shown. Method 500 may be implemented on a computing device or a similar electronic device capable of executing instructions through at least one processor. Method 500 begins at operation 602 where a plurality of user progression states corresponding to a plurality of actions to be completed by a user while using the application are stored. In one example, the plurality of user progression states may be stored at an application service associated with the application. In one example, the application service associated with the application includes a cloud storage service such as OneDrive, Sharepoint, and the like. In this regard, the state of the user and actions completed across multiple endpoints may be tracked. In one example, the plurality of user progression states may indicate a status of a user with regard to completing the plurality of actions to be completed while using the application. In one example, the plurality of actions to be completed include performing an upload, accessing a mobile application, accessing a sync client, sharing a file, and upgrading an account. In one example, the application is at least one of a mobile application, a sync client, and a web application.

When a plurality of user progression states corresponding to a plurality of actions to be completed by a user while using the application are stored, flow proceeds to operation 504 where at least one of the plurality of user progression states is updated when a first action of the plurality of actions is completed on a first endpoint. In one case, at least one of the plurality of user progression states may be updated when any action of the plurality of actions to be completed by the user is completed on the first endpoint. In one example, the user progression state is updated in the application service where it is stored. In one example, the first endpoint comprises at least one of a mobile phone, a tablet device, and a desktop device. In examples, at least one action of the plurality of actions is associated with an endpoint on which the action is to be completed. In one example, when the at least one action includes accessing a mobile application, the endpoint on which the action is to be completed is at least one of a mobile phone and a tablet device. In another example, when the at least one action includes accessing a sync client, the endpoint on which the action is to be completed is at least one of a desktop device and a tablet device.

When at least one of the plurality of user progression states is updated when a first action of the plurality of actions is completed on a first endpoint, flow proceeds to operation 606 where at least one of the plurality of user progression states is updated when a second action of the plurality of actions to be completed by the user is completed on a second endpoint. In one case, at least one of the plurality of user progression states may be updated when any action of the plurality of actions to be completed by the user is completed on the second endpoint. In one case, at least one of the plurality of user progression states may be updated when any action of the plurality of actions to be completed by the user is completed on any endpoint. In one example, the user progression state is updated in the application service where it is stored. In one example, the second endpoint comprises at least one of a mobile phone, a tablet device, and a desktop device. In one example, the first endpoint is different from the second endpoint. In another example, the first endpoint is the same as the second endpoint. In examples, at least one action of the plurality of actions is associated with an endpoint on which the action is to be completed.

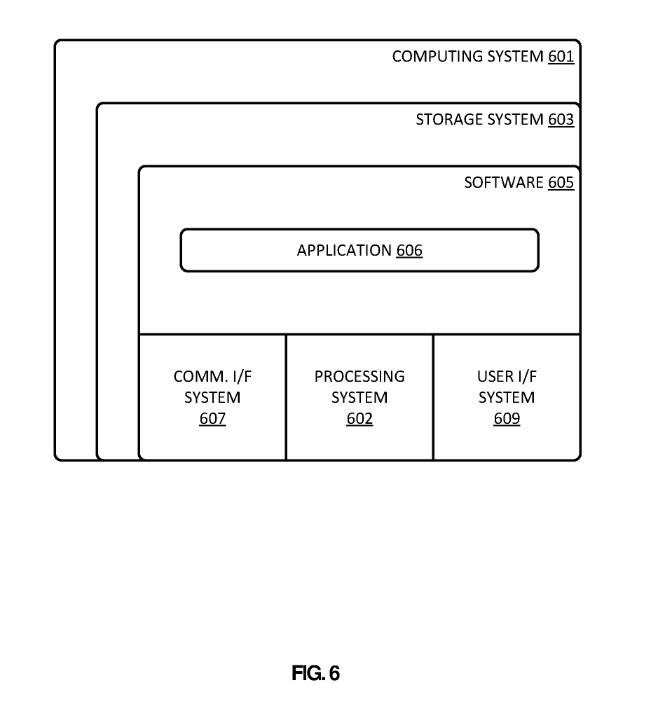

FIG. 6 illustrates computing system 601 that is representative of any system or collection of systems in which the various applications, services, scenarios, and processes disclosed herein may be implemented. Examples of computing system 601 include, but are not limited to, server computers, rack servers, web servers, cloud computing platforms, and data center equipment, as well as any other type of physical or virtual server machine, container, and any variation or combination thereof. Other examples may include smart phones, laptop computers, tablet computers, desktop computers, hybrid computers, gaming machines, virtual reality devices, smart televisions, smart watches and other wearable devices, as well as any variation or combination thereof.

Computing system 601 may be implemented as a single apparatus, system, or device or may be implemented in a distributed manner as multiple apparatuses, systems, or devices. Computing system 601 includes, but is not limited to, processing system 602, storage system 603, software 605, communication interface system 607, and user interface system 609. Processing system 602 is operatively coupled with storage system 603, communication interface system 607, and user interface system 609.

Processing system 602 loads and executes software 605 from storage system 603. Software 605 includes application 606, which is representative of the applications discussed with respect to the preceding FIGS. 1-4, including the application views described herein. When executed by processing system 602 to enhance guided action systems, software 605 directs processing system 602 to operate as described herein for at least the various processes, operational scenarios, and sequences discussed in the foregoing implementations. Computing system 601 may optionally include additional devices, features, or functionality not discussed for purposes of brevity.

Referring still to FIG. 5, processing system 602 may comprise a micro-processor and other circuitry that retrieves and executes software 605 from storage system 603. Processing system 602 may be implemented within a single processing device, but may also be distributed across multiple processing devices or sub-systems that cooperate in executing program instructions. Examples of processing system 602 include general purpose central processing units, application specific processors, and logic devices, as well as any other type of processing device, combinations, or variations thereof.

Storage system 603 may comprise any computer readable storage media readable by processing system 602 and capable of storing software 605. Storage system 603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 603 may also include computer readable communication media over which at least some of software 605 may be communicated internally or externally. Storage system 603 may be implemented as a single storage device, but may also be implemented across multiple storage devices or sub-systems co-located or distributed relative to each other. Storage system 603 may comprise additional elements, such as a controller, capable of communicating with processing system 602 or possibly other systems.

Software 605 may be implemented in program instructions and among other functions may, when executed by processing system 602, direct processing system 602 to operate as described with respect to the various operational scenarios, sequences, and processes illustrated herein. For example, software 605 may include program instructions for implementing enhanced guided action system.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 605 may include additional processes, programs, or components, such as operating system software, virtual machine software, or other application software, in addition to or that include application 606. Software 605 may also comprise firmware or some other form of machine-readable processing instructions executable by processing system 602.

In general, software 605 may, when loaded into processing system 602 and executed, transform a suitable apparatus, system, or device (of which computing system 601 is representative) overall from a general-purpose computing system into a special-purpose computing system customized to facilitate enhanced guided action systems. Indeed, encoding software 605 on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary storage, as well as other factors.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 607 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 609 is optional and may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 609. In some cases, the input and output devices may be combined in a single device, such as a display capable of displaying images and receiving touch gestures. The aforementioned user input and output devices are well known in the art and need not be discussed at length here.

User interface system 609 may also include associated user interface software executable by processing system 602 in support of the various user input and output devices discussed above. Separately or in conjunction with each other and other hardware and software elements, the user interface software and user interface devices may support a graphical user interface, a natural user interface, or any other type of user interface.

Communication between computing system 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

Among other examples, the present disclosure presents systems comprising: one or more computer readable storage media; and program instructions stored on the one or more computer readable storage media that, when executed by at least one processor, cause the at least one processor to at least: present an action control within an application including a plurality of actions to be completed by a user while using the application; present at least a first action of the plurality of actions in the action control when the application is accessed by a first endpoint; and subsequent to the first action being completed, present at least a second action in the action control when the application is accessed by a second endpoint; wherein at least one action of the plurality of actions is associated with an endpoint on which the action is to be completed. In further examples, the action control is presented as a single region within the application. In further examples, the action control is presented as a series of user interface cards within the application. In further examples, the application is at least one of a mobile application, a sync client, and a web application. In further examples, the plurality of actions include performing an upload, accessing a mobile application, accessing a sync client, sharing a file, and upgrading an account. In further examples, a plurality of user progression states corresponding to the plurality of actions to be completed by the user while using the application are stored in an application service associated with the application. In further examples, the first endpoint comprises at least one of a mobile phone, a tablet device, and a desktop device. In further examples, the second endpoint comprises at least one of a mobile phone, a tablet device, and a desktop device. In further examples, a visual indication is displayed to indicate that an action has been completed.

Further aspects disclosed herein provide an exemplary computer-implemented method for facilitating user progress while navigating an application, the method comprising: sending a request to an application service associated with the application for a current user progression state corresponding to an action of a plurality of actions to be completed by a user while using the application; receiving a response to the request, the response including at least a next action of the plurality of actions to be completed by the user; presenting at least the next action of the plurality of actions to be completed by the user within the application in a user interface of an endpoint; wherein at least one action of the plurality of actions is associated with the endpoint on which the action is to be completed. In further examples, the computer-implemented method further comprises presenting, in addition to the next action to be completed by the user, each action of the plurality of actions that have been completed by the user within the application. In further examples, presenting the next action to be completed by the user within the application comprises highlighting the next action to be completed such that it appears selected. In further examples, the computer-implemented method further comprises presenting the plurality of actions to be completed by the user within the application in the user interface of another endpoint. In further examples, the computer-implemented method further comprises receiving an input corresponding to an action of the plurality of actions to be completed on the another endpoint. In further examples, the next action presented is based on a last presented action. In further examples, the next action presented is based on at least the endpoint on which the application is accessed and which actions of the plurality of actions have been completed.

Additional aspects disclosed herein provide an exemplary system comprising at least one processor; and memory encoding computer executable instructions that, when executed by the at least one processor, perform a method for tracking user progression states of an application across multiple endpoints, the method comprising: storing a plurality of user progression states corresponding to a plurality of actions to be completed by a user while using the application; updating at least one of the plurality of user progression states when a first action of the plurality of actions is completed on a first endpoint; and updating at least one of the plurality of user progression states when a second action of the plurality of actions to be completed by the user is completed on a second endpoint; wherein at least one action of the plurality of actions is associated with an endpoint on which the action is to be completed. In further examples, the first endpoint is different from the second endpoint. In further examples, when the at least one action includes accessing a mobile application, the endpoint on which the action is to be completed is at least one of a mobile phone and a tablet device. In further examples, when the at least one action includes accessing a sync client, the endpoint on which the action is to be completed is at least one of a desktop device and a tablet device.

Techniques for tracking user progress as a user navigates an application across multiple endpoints are described. Although aspects are described in language specific to structural features and/or methodological acts, it is to be understood that the aspects defined in the appended claims are not necessarily limited to the specific features or acts described above. Rather, the specific features and acts are disclosed as example forms of implementing the claimed aspects.

A number of methods may be implemented to perform the techniques discussed herein. Aspects of the methods may be implemented in hardware, firmware, or software, or a combination thereof. The methods are shown as a set of blocks that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods may be implemented via interaction between various entities discussed above with reference to the touchable user interface.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an aspect with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Additionally, while the aspects may be described in the general context of guided action tools that execute in conjunction with an application that runs on an operating system on a computing device, those skilled in the art will recognize that aspects may also be implemented in combination with other program modules. In further aspects, the aspects disclosed herein may be implemented in hardware.

Generally, program modules include routines, programs, components, data structures, and other types of structures that perform particular tasks or implement particular abstract data types. Moreover, those skilled in the art will appreciate that aspects may be practiced with other computer system configurations, including hand-held devices, multiprocessor systems, microprocessor-based or programmable consumer electronics, minicomputers, mainframe computers, and comparable computing devices. Aspects may also be practiced in distributed computing environments where tasks are performed by remote processing devices that are linked through a communications network. In a distributed computing environment, program modules may be located in both local and remote memory storage devices.

Aspects may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or compact servers, an application executed on a single computing device, and comparable systems.

What is claimed is:

1. A system comprising:
one or more computer readable storage media; and
program instructions stored on the one or more computer readable storage media that, when executed by at least one processor, cause the at least one processor to at least:
present an action control within an application including a plurality of actions to be completed by a user while using the application;
present at least a first action of the plurality of actions in the action control when the application is accessed by a first endpoint; and
subsequent to the first action being completed, present at least a second action in the action control when the application is accessed by a second endpoint;
wherein at least one action of the plurality of actions is associated with an endpoint on which the action is to be completed.

2. The system of claim 1, wherein the action control is presented as a single region within the application.

3. The system of claim 1, wherein the action control is presented as a series of user interface cards within the application.

4. The system of claim 1, wherein the application is at least one of a mobile application, a sync client, and a web application.

5. The system of claim 1, wherein the plurality of actions include performing an upload, accessing a mobile application, accessing a sync client, sharing a file, and upgrading an account.

6. The system of claim 1, wherein a plurality of user progression states corresponding to the plurality of actions to be completed by the user while using the application are stored in an application service associated with the application

7. The system of claim 1, wherein the first endpoint comprises at least one of a mobile phone, a tablet device, and a desktop device.

8. The system of claim 1, wherein the second endpoint comprises at least one of a mobile phone, a tablet device, and a desktop device.

9. The system of claim 1, wherein a visual indication is displayed to indicate that an action has been completed.

10. A computer-implemented method for facilitating user progress while navigating an application, the method comprising:
sending a request to an application service associated with the application for a current user progression state corresponding to an action of a plurality of actions to be completed by a user while using the application;
receiving a response to the request, the response including at least a next action of the plurality of actions to be completed by the user;
presenting at least the next action of the plurality of actions to be completed by the user within the application in a user interface of an endpoint;
wherein at least one action of the plurality of actions is associated with the endpoint on which the action is to be completed.

11. The computer-implemented method of claim 10, further comprising presenting, in addition to the next action to be completed by the user, each action of the plurality of actions that have been completed by the user within the application.

12. The computer-implemented method of claim 10, wherein presenting the next action to be completed by the user within the application comprises highlighting the next action to be completed such that it appears selected.

13. The computer-implemented method of claim 10, further comprising presenting the plurality of actions to be completed by the user within the application in the user interface of another endpoint.

14. The computer-implemented method of claim 13, further comprising receiving an input corresponding to an action of the plurality of actions to be completed on the another endpoint.

15. The computer-implemented method of claim 10, wherein the next action presented is based on a last presented action.

16. The computer-implemented method of claim 10, wherein the next action presented is based on at least the endpoint on which the application is accessed and which actions of the plurality of actions have been completed.

17. A system comprising:
at least one processor; and
memory encoding computer executable instructions that, when executed by the at least one processor, perform a method for tracking user progression states of an application across multiple endpoints, the method comprising:
storing a plurality of user progression states corresponding to a plurality of actions to be completed by a user while using the application;
updating at least one of the plurality of user progression states when a first action of the plurality of actions is completed on a first endpoint; and
updating at least one of the plurality of user progression states when a second action of the plurality of actions to be completed by the user is completed on a second endpoint;
wherein at least one action of the plurality of actions is associated with an endpoint on which the action is to be completed.

18. The system of claim 17, wherein the first endpoint is different from the second endpoint.

19. The system of claim 17, wherein when the at least one action includes accessing a mobile application, the endpoint on which the action is to be completed is at least one of a mobile phone and a tablet device.

20. The system of claim 17, wherein when the at least one action includes accessing a sync client, the endpoint on which the action is to be completed is at least one of a desktop device and a tablet device.
